(19) United States
(12) Patent Application Publication
(10) Pub. No.: US 2018/0373213 A1
(43) Pub. Date: Dec. 27, 2018

(54) FIELDBUS COUPLER AND SYSTEM METHOD FOR CONFIGURING A FAILSAFE MODULE

(71) Applicant: Weidmüller Interface GmbH & Co. KG, Detmold (DE)

(72) Inventor: Gorm ROSE, Paderborn (DE)

(21) Appl. No.: 16/061,143

(22) PCT Filed: Dec. 16, 2016
(86) PCT No.: PCT/EP2016/081339

§ 371 Date: Jun. 11, 2018

(30) Foreign Application Priority Data
Dec. 17, 2015 (DE) 10 2015 122 066.0

(51) Int. Cl. G05B 19/042; G05B 9/02; H04L 12/40

(52) U.S. Cl. CPC G05B 19/0425; G05B 19/0426; H04L 2012/4026; H04L 12/40; G05B 2219/25157; G05B 9/02

(57) ABSTRACT

A method for configuring a failsafe module, which is connected to a field bus coupler of an industrial automation system via a sub-bus in order to transmit security-related data of the module via a field bus, utilizes a number of steps, The type of security protocol that is compatible with the field bus is determined via the field bus coupler, and configuration instructions are transmitted to at least one failsafe module via the field bus coupler in order to enable the module to use the determined type of security protocol. Furthermore, a field bus coupler or a system comprising a field bus coupler and at least one failsafe module is designed to implement the method.

This application is a § 371 of PCT/EP2016/081339 filed Dec. 16, 2016. PCT/EP2016/081339 claims priority of DE 10 2015 1.220660 filed Dec. 17, 2015. The entire contents of these applications are incorporated herein by reference.

### BACKGROUND OF THE DISCLOSURE

The disclosure relates to a method for configuring a failsafe module, hereinafter referred to as an FS module, which is connected to a fieldbus coupler of an industrial automation system via a sub-bus in order to transmit security data of the FS module via a field bus. The disclosure further relates to a field bus coupler and a system including a field bus coupler and an FS module that is suitable for implementing the method.

In industrial automation systems, field buses are used for transmitting control data and/or measured values between one or more central control computers, also referred to as host computers or programmable logic controllers (PLCs), and field devices. The field devices may, for example, be sensors and or actuators associated with the industrial automation system. It is often the case that not every single field device is coupled directly to the fieldbus, but rather via a fieldbus coupler which forms an interface between the fieldbus, on the one hand, and an often-proprietary sub-bus, on the other, whereby a plurality of bus-capable modules may be coupled to the sub-bus.

A number of different configurations of these modules is known. The modules may, for example, provide digital and/or analog input and/or output channels, and may be designed as signal converters or relay modules, counter modules or interface modules for other buses. Collectively, the system including fieldbus couplers and connected modules is also referred to as a modular, decentralized input and output station, or briefly as a remote I/O.

In order to process security-related data, industrial automation systems require special safety precautions, something that cannot be ensured by the protocols generally used in a fieldbus and/or sub-bus. To achieve secure data transmission with a sufficiently high level of data redundancy and provide monitoring mechanisms for detecting missing and/or erroneous data, special security-related data protocols have been developed. Such protocols for functionally secure transmissions are also termed fail-safe protocols or security protocols. By way of example, such protocols include PROFIsafe, Fail Safe over EtherCAT (FSoE) or OpenSAFETY.

Since security protocols are data- and processing-intensive, usually not all of the fieldbus communication is done using these protocols. Instead, the security-related data is converted according to a security protocol into data packets or containers which are then transported using the normal fieldbus protocol. For example, security protocol checksums ensure that inadvertent corruption of the packets during transport via the fieldbus or the sub-bus is excluded or will not go undetected.

To enable flawless transmission of security-related data, care must be taken when setting up and configuring an industrial automation system that all security-related components, including for example FS modules, as well as control computers evaluating the security-related data such as a programmable logic controller (PLC), use a uniform security protocol, which in addition must be supported by the employed fieldbus protocol and therefore must be compatible with the employed fieldbus protocol.

### SUMMARY OF THE DISCLOSURE

An object of the present disclosure is to prevent an arrangement of non-compatible security-related components in a simple and comprehensive way to enhance the functional reliability of the industrial automation system. A further object is to create a fieldbus coupler or a system of fieldbus couplers and connected FS modules that contributes to enhancing the security of the industrial automation system.

In accordance with a method for configuring an FS module, a fieldbus coupler determines a security protocol type that is compatible with the fieldbus. The fieldbus coupler subsequently transmits configuration instructions to at least one FS module to enable the FS module to use the determined type of security protocol.

The fieldbus coupler converts the fieldbus protocol to the protocol used in the sub-bus or packages it into protocol-compliant packets if it must be ensured that the content will not be compromised as is done by security protocols. The fieldbus coupler thus represents the link between the fieldbus and the FS modules. The fieldbus coupler determining the employed security protocol and the subsequent configuration of the connected FS modules is advantageous in that not every FS module needs to perform such an evaluation independently, or be enabled to carry out such an evaluation.

Thus, according to the disclosure, automatic configuration of at least one FS module for using the correct security protocol is achieved. That way, the correct configuration of the security protocol in the FS module is automated and less error-prone.

The fieldbus coupler may be an independent component, which is connected via the fieldbus to a control computer or to a security-control computer. However, the fieldbus coupler may also be integrated in the control computer or the security-control computer, as is the case for example with compact controllers. Compact controllers directly provide a sub-bus, to which input and output modules, including security modules, are connectable. Internally, at least on the physical level but also on the logical level, the fieldbus protocol is converted to the sub-bus protocol by the integrated fieldbus coupler.

In one embodiment of the method, the type of security protocol is determined based on an evaluation of a message sent via the fieldbus and the sub-bus to the fail-safe module. This utilizes the fact that following a system start, messages are usually sent from a control computer or a security-control computer to any existing FS modules for capture or configuration. These messages can be evaluated by the fieldbus coupler to determine the type of security protocol used.

Message checksums may preferably be generated thereby for evaluation in various predefined ways, which are characteristic of the type of security protocol. The type of security protocol can then be determined based on a comparison with a checksum contained in the message. It makes use of fact that various known types of security protocols use different algorithms for determining the checksum. The type of checksum generation that is used can be determined by the trial-and-error method allowing for the employed security protocol to be deduced.

According to another embodiment of the method, the type of fieldbus already connected or to be connected to the fieldbus coupler is initially determined by the fieldbus coupler. The type of security, protocol is then determined based on this information. Certain types, of utilized field buses are generally, or in some cases necessarily, associated with certain security protocols to be used. When the fieldbus coupler has detected the type of security protocol to be used, configuration instructions are preferably transmitted from the fieldbus coupler via the sub-bus to at least one fail-safe module in order to enable the fail-safe module to use the determined type of security protocol. Due to its arrangement between the fieldbus and the FS module, the field bus coupler, which is already connected or set up to be connected to a fieldbus, is particularly suitable for determining the type of fieldbus already connected or to be connected and selecting the appropriate security protocol, as well as configuring the FS module via the sub-bus.

In another embodiment of the method, the aforesaid configuration method is carried out for several and preferably all of the fail-safe modules connected to the sub-bus, in case more than one FS module is connected.

In a further embodiment of the method, it is determined whether one of the fail-safe modules is unsuitable for use with the required security protocol. For example, an FS module may only be suitable for use with a particular, non-compliant security protocol, and may not be reconfigurable. It is also conceivable that an FS module is basically reconfigurable and may be operated using different security protocols, just not the preferred one. If such an incompatible FS module is identified, the configuration process may be aborted and a warning signal issued directly to the fieldbus coupler, or a warning message issued from the fieldbus coupler via the fieldbus to the control computer, a special security-control computer, or to a monitoring system of the industrial automation system.

A fieldbus coupler of the type mentioned above or a system including such a fieldbus coupler and at least one connected fail-safe module is set up to perform the method described above. This results in the advantages mentioned in connection with the method.

### BRIEF DESCRIPTION OF THE FIGURES

Other objects and advantages of the present disclosure will become apparent from a review of the following description when viewed in the light of the accompanying thawing, in which:

FIG. 1 shows a block diagram of an industrial automation system including a fieldbus coupler and fail-safe modules; and

FIG. 2 shows a flow diagram of a method for configuring a fail-safe module connected to a fieldbus coupler.

### DETAILED DESCRIPTION

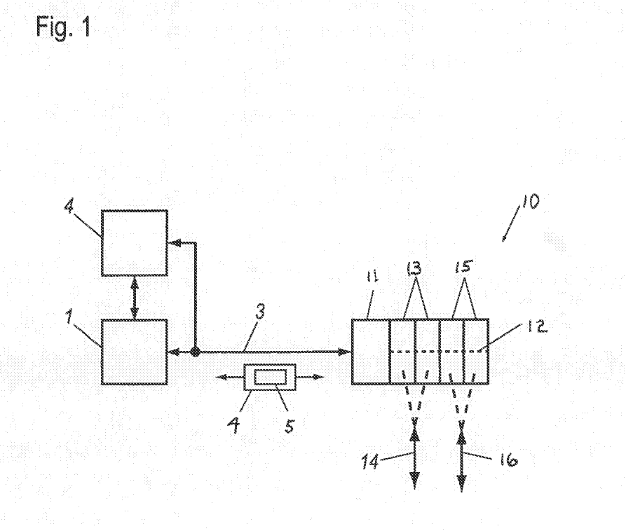

FIG. 1 shows a schematic representation of an industrial automation system for controlling an industrial system, not shown.

The automation system has a control computer 1 which is connected via a field bus 3 to a remote input and output station 10 or Remote I/O. The fieldbus 3 can be designed according to a known standard, such as PROFIBUS, PROFINET, Modbus or EtherCAT, and use a corresponding fieldbus protocol 4. The fieldbus protocol 4 of the fieldbus 3 described below and represented by exchanged data in FIG. 1.

The input and output station 10 includes a field bus coupler 11 which is connected to the fieldbus 3. The fieldbus coupler 11 converts data exchanged via the fieldbus 3 to a serial sub-bus 12 through which various modules are coupled to the fieldbus coupler 11.

In addition to the sub-bus 12, which in this embodiment serves only to transmit data, a further bus, not shown, for powering the modules and/or the fieldbus coupler 11 may be present at the input and output station 10. Power supply modules are additionally provided for supplying current and may be arranged at one end of the illustrated module arrangement or between the modules with the fieldbus coupler and the modules.

Among the Modules of the input and output station 10, two input and output modules 13 are shown by way of example and via whose connections measurement and control signals are exchanged as input and output signals 14 for the system to be controlled.

Moreover, two modules 15 such as FS modules 15, which receive or output security-related signals 16, are present.

The input and output modules 13 are addressed by the fieldbus coupler 11 via the sub-bus 12. Input data, which determine the input and output modules 13 based on incoming input or output signals 14, is converted by the fieldbus coupler 11 to data packets in accordance with the fieldbus protocol 4, and sent to the control computer 1. Conversely, output or configuration values received by the control computer 1 for the input and, output modules 13 are accepted by the fieldbus coupler 11 and forwarded to the input and output module 13 via the sub-bus 12.

Similarly, the security-related signals 16, such as incoming signals from light barriers or light gates, door contacts or emergency buttons, or the like are converted by the corresponding FS module 15 and packed into a data container according to a security protocol 5. This data container is sent by the FS module 15 via the sub-bus 12 to the fieldbus coupler 11, where it is packed without manipulation into packets according to the fieldbus protocol 4, and sent via the fieldbus 3. The security-related data according to the security protocol 5 can be evaluated in control computer 1. Alternatively, a safety controller 2 which represents an independent control system for security-related issues may be provided. The safety and control computer 2 is likewise connected to the fieldbus 3 and exchanges data with the control computer 1.

The security protocol 5 considers security-related issues and is provided to ensure secure data transmission such as by encryption mechanisms and redundant transmission. Furthermore, monitoring mechanisms are provided, via which a missing or faulty data exchange may be detected. The security protocol 5 may be a known protocol, such as PRO-FIsafe or OpenSAFETY.

Operation of the industrial automation system, including the FS modules 15, assumes that the FS modules 15 are able to utilize the appropriate security protocol 5 and are configured correctly for applying this security protocol 5.

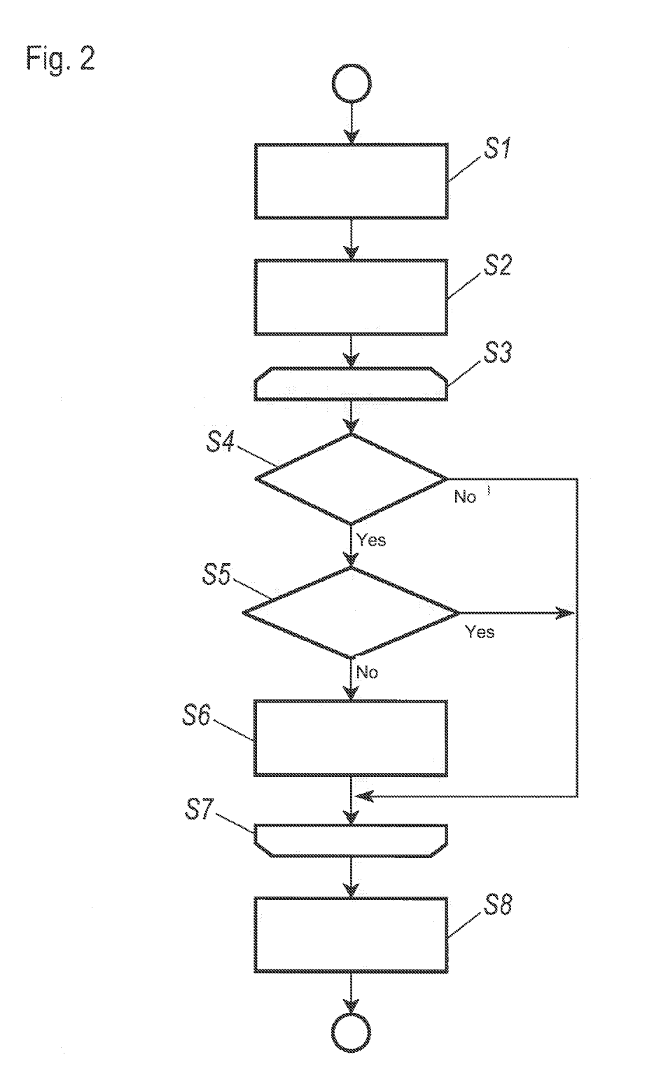

This is achieved by automatically configuring the FS modules 15. A suitable method for configuring FS modules 15 of an input and output station 10 is explained below with reference to the flowchart of FIG. 2. For example, the method may be implemented by the industrial automation system illustrated in FIG. 1. The method is explained below by way of example with reference to the features and reference numerals of FIG. 1.

The depicted configuration method is implemented by the system including fieldbus coupler 11 and FS modules 15, for instance, as soon as changes occur in the combination of the modules 13,15 connected to the fieldbus coupler 11. The method may also be carried out with each restart of the fieldbus coupler 11, such as for example, after application of supply voltage. At input and output stations 10, whose arrangement may be changed during operation, any change in the combination may result in the execution of the configuration process. A change in the combination May be done through regular polling of the connected modules.

Upon starting the method, the fieldbus protocol 4 to be used is determined by the fieldbus coupler 11 in an initial step S1. In the event that the fieldbus coupler 11 is suitable for use only with fieldbus protocol 4, the fieldbus protocol 4 to be applied is inherently determined. If the fieldbus coupler 11 is suitable for use with different fieldbus protocols, the information concerning the fieldbus protocol 4 to be used can be gleaned from the configuration data of fieldbus coupler 11.

In a subsequent step S2, the fieldbus coupler 11 determines the type of desired safety protocol 5 based on the information concerning the fieldbus protocol 4 to be used. To this end, various options are again available, if required. Certain fieldbus protocols require a single, special type of security protocol 5. In this case, the type of desired security protocol 5 results directly from the utilized fieldbus protocol 4. In cases where in principle different security protocols 5 may be replaced by the type of fieldbus used, the desired security protocol 5 is typically stored in the configuration data of the fieldbus coupler 11, or automatically detected.

Alternative embodiments may provide for the determination of the type of desired security protocol 5 based on a (first) message sent by the control computer 1, or the security-control computer 2, to the FS module 15. For example, upon starting the system, messages are often sent by the control computer 1, or a security-control computer 2, to any existing FS modules 15, for example as a so-called “broadcast” message, which reaches all existing FS modules 15 in order to detect or configure them. This message may be evaluated either by the FS module 15 independently or the fieldbus coupler 11 in order to determine the type of security protocol used.

For evaluation purposes, message checksums may be generated in various predefined ways that are characteristic of the type of security protocol. Based on a comparison with a checksum contained in the message, the type of security protocol 6 already used by the control computer 1 or the security-control computer 2 can then be determined. The various known types of security protocols generally use different algorithms in order to determine the checksum. The type of checksum used is then determined by the trial-and-error method and the security protocol used is deduced therefrom.

Subsequently, the method passes through a loop structure between steps S3 and S7. As part of this loop, all connected modules 13, 15 are successively addressed and handled as part of the steps S4 to S6 executed in the loop. It will be understood that alternative embodiments of the method may provide for the method not to take into consideration all the connected modules, but instead will relate specifically to individual modules or a group of specific modules,

When first cycling through the steps S4 to S6, step S4 determines, whether the first module is a reconfigurable FS module. If negative, steps S5 and S6 are skipped and the loop structure between steps S3 and S7 is cycled with the next module connected to sub-bus 12.

If step S4 determines that the module currently being handled is a reconfigurable FS module, for example one of the FS modules 15 according to FIG. 1, then step S5 polls whether the module is currently set up to use the desired security protocol 5. If it has already been set up accordingly, then step S6 is again skipped and the loop structure of steps S4-S6 is executed for the next module.

If step S5 determines that the currently considered FS module 15 is not set up to use the desired security protocol 5, then the method continues to step S6, whereby the fieldbus coupler 11 sends a configuration instruction to the FS module 15 via sub-bus 12 in order to set up the FS module 15 for use with the desired security protocol 5.

The S4 to S6 loop of steps controlled by the steps S3 and S7 is thus processed for all of the modules.

In a subsequent step S8, the sub-bus 12 is optionally restarted; to execute, for example, addressing routines and/or routines for loading the current configurations of the connected modules 13,15 into a configuration memory of the fieldbus coupler 11. However, this step is only required if the corresponding configuration memory of the fieldbus coupler 11 was not already updated in parallel with configuration step S6. After step S8, the automatic configuration process for the FS modules 15 ends at sub-bus 12.

Alternative embodiments of the method, in addition to the automatic configuration of the FS modules 15, may provide recognition of incorrectly configurable FS modules. For example, steps S4 to S6 may also provide for polling of whether one of the FS modules 15 cannot be set up for the desired security protocol, e.g., because it does not support the desired security protocol. However, it is also conceivable that one of the FS modules, in principle, only supports a specific security protocol that happens not to match the desired one.

A detected incompatibility that is not recoverable by reconfiguration can either he signaled to the fieldbus coupler 11 or transmitted from the fieldbus coupler 11 to the control computer 1 or the security-control computer 2 as a warning.

While the preferred forms and embodiments of the disclosure have been illustrated and described, it will be apparent to those of ordinary skill in the art that various changes and modifications may be made without deviating from the concepts set forth above.

1-10. (canceled)

11. A method for configuring a failsafe module which is connected to a field bus coupler of an industrial automation system via a sub-bus in order to transmit security-related data of the module via a field bus, comprising the steps of
(a) determining a type of security protocol that is compatible with the fieldbus via the field bus coupler; and
(b) transmitting configuration instructions to at least one fail-safe module via the fieldbus couple to enable the fail-safe module to use the determined type of security protocol.

12. A method as defined in claim 11, wherein the type of security protocol is determined based on an evaluation of a message sent via the fieldbus and the fieldbus coupler to the fail-safe module.

13. A method as defined in claim 12, and further comprising the steps of generating message checksums in various predefined ways that are characteristic of the type of security protocol for evaluation purposes and determining the type of security protocol in the fieldbus coupler based on a comparison with a checksum contained in the message.

14. A method as defined in claim 11, wherein the type of fieldbus connected with the fieldbus coupler is determined by the fieldbus coupler and the type of security protocol is identified by the fieldbus coupler based on the type of fieldbus.

15. A method as defined in claim 11, and further comprising the step of transmitting configuration instructions from the fieldbus coupler via the sub-bus to at least one fail-safe module in order to enable the fail-safe module to use the determined type of security protocol.

16. A method as defined in claim 11, wherein at least one of the fail-safe modules connected to the sub-bus are configured by the fieldbus coupler.

17. A method as defined in claim 11, wherein the fieldbus coupler checks whether a fail-safe module connected with the sub-bus is unsuitable for using the determined type of security protocol.

18. A method as defined in claim 17, wherein one of a warning signal and a warning message is output by the fieldbus coupler if it is determined that a fail-safe module unsuitable for using the determined safety protocol is connected to the sub-bus.

19. A fieldbus coupler for coupling at least one fail-safe module via a sub-bus to a fieldbus of an industrial automation system, wherein a fieldbus coupler is established to perform a method for configuring at least one fail-safe module according to claim 11.

20. A system comprising a fieldbus coupler including at least one connected fail-safe module coupled via a fieldbus coupler and a sub-bus to a fieldbus of an industrial automation system for implementing a method for configuring at least one fail-safe module as defined in claim 11.
